(19) United States
(12) Patent Application Publication
(10) Pub. No.: US 2025/0060225 A1
(43) Pub. Date: Feb. 20, 2025

(54) VEHICLE DISPLAY WITH NAVIGATION AND RADAR MAP OVERLAY

(71) Applicant: FCA US LLC, Auburn Hills, MI (US)

(72) Inventors: Chong Kim, Wixom, MI (US); Rena Darbyshire, Lake Orion, MI (US); Denny Vidinovski, Dearborn Heights, MI (US)

(21) Appl. No.: 18/449,753

(22) Filed: Aug. 15, 2023

(51) Int. Cl. G01C 21/36

(52) U.S. Cl. CPC G01C 21/3694

(57) ABSTRACT

A method of controlling a display screen in a vehicle, includes obtaining and displaying map data and weather information on a display screen. The map data obtained from a navigation source and may include a path of travel and at least part of a geographic region adjacent to the path of travel. The weather information may be obtained from a weather source, may be displayed as a function of the geographic region. The display of weather information may be adjusted as a function of the part of the map data on the display screen so that the weather information is overlayed on the map data and both the weather information and the map data are visible simultaneously.

### FIELD

The present disclosure relates to a vehicle navigation system including a display that may be used for navigation information and which includes a weather radar map overlay.

### BACKGROUND

Driving a vehicle in bad weather can be challenging or unsafe. While driving, it is difficult to obtain weather information for either a current location or a future location. If a navigation program with a display provided on mobile device is being used, the navigation program must be taken off the display and a separate program used to find weather information that is separately displayed on the mobile device. If a navigation program includes a display within the vehicle, then typically a second device, like a mobile phone, must also be used to find weather information.

### SUMMARY

In at least some implementations, a method of controlling a display screen in a vehicle, includes obtaining and displaying map data and weather information on a display screen. The map data obtained from a navigation source and may include a path of travel and at least part of a geographic region adjacent to the path of travel. The weather information may be obtained from a weather source, may be displayed as a function of the geographic region. The display of weather information may be adjusted as a function of the part of the map data on the display screen so that the weather information is overlayed on the map data and both the weather information and the map data are visible simultaneously.

In at least some implementations, the step of adjusting the display of weather information includes adjusting a scale of the weather information as a function of a scale of the map data. In at least some implementations, the step of adjusting the display of weather information includes adjusting the transparency of the display of weather information so that the map data is visible through the display of weather information.

In at least some implementations, the step of adjusting the display of weather information includes adjusting the transparency of the display of weather information so that the map data is visible through the display of weather information. In at least some implementations, the weather information is provided in a first layer displayed on the display screen and the map data is provided on a second layer displayed on the display screen.

In at least some implementations, the weather information includes time-sensitive data for the weather as a function of the estimated time of vehicle travel along portions of the path of travel.

In at least some implementations, the method includes matching the weather information displayed to the estimated time of vehicle travel through the portion of the path of travel actively displayed on the display screen. In at least some implementations, a current time-wise weather information is displayed when the portion of the path of travel actively displayed includes the current location of the vehicle. In at least some implementations, a forecasted weather information is displayed when the portion of the path of travel actively displayed includes a future location of the vehicle. In at least some implementations, the portion of the path of travel being actively displayed is less than the entire path of travel.

In at least some implementations, the weather information includes data regarding rate of rainfall, wind speeds, and potential severe weather that includes one or more of wind speeds above 50 mph, hail, tornado and fog. In at least some implementations, the data includes graphic representations that include different colors for different severities of the data.

In at least some implementations, the weather information includes a textual description of the current weather or forecasted weather. In at least some implementations, the method includes comparing the weather information to one or more weather thresholds and issuing an advisory output if one or more of the weather thresholds are met. In at least some implementations, the one or more weather thresholds include a temperature threshold. In at least some implementations, the one or more weather thresholds includes a wind speed threshold, a tornado forecast threshold, a rain intensity threshold or a fog threshold.

In at least some implementations, the step of displaying at least part of the map data on a display screen includes displaying the current location of the vehicle on the display screen.

In at least some implementations, a vehicle infotainment system includes a display screen, a controller coupled to the display screen and adapted to control content displayed on the display screen, a navigation source communicated with the controller and adapted to provide map data including a path of travel to the controller for display on the display screen, and a communications device. The communications device is coupled to the controller and adapted to obtain the map data from the navigation system for display on the display screen, and to obtain weather information from a weather information source, wherein the weather information relates to a geographic area that is a function of the map data. The controller is adapted to adjust a display size of the weather information as a function of a display size of the map data, and the controller is adapted to adjust a transparency of the display of weather information and overlay the weather information over the display of the map data with both the weather information and the map data simultaneously visible on the display screen.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 shows a portion of a vehicle interior including a display screen that is part of a Human-Machine Interface;

FIG. 2 is a diagrammatic view of a system for providing and displaying map data and weather information;

FIG. 3 is a view of a display screen showing map data including an entire path of travel and weather information;

FIG. 4 is a view similar to FIG. 3 but showing a smaller geographic area and a remaining portion of a path of travel;

FIG. 5 is a flowchart of a method for displaying map data and weather information;

FIG. 6 is a flowchart of a subroutine for adjusting obtained weather information to correspond to the displayed map data; and

FIG. 7 is a flowchart of a subroutine for providing an advisory output if one or more weather thresholds are or will be met along a path of travel.

### DETAILED DESCRIPTION

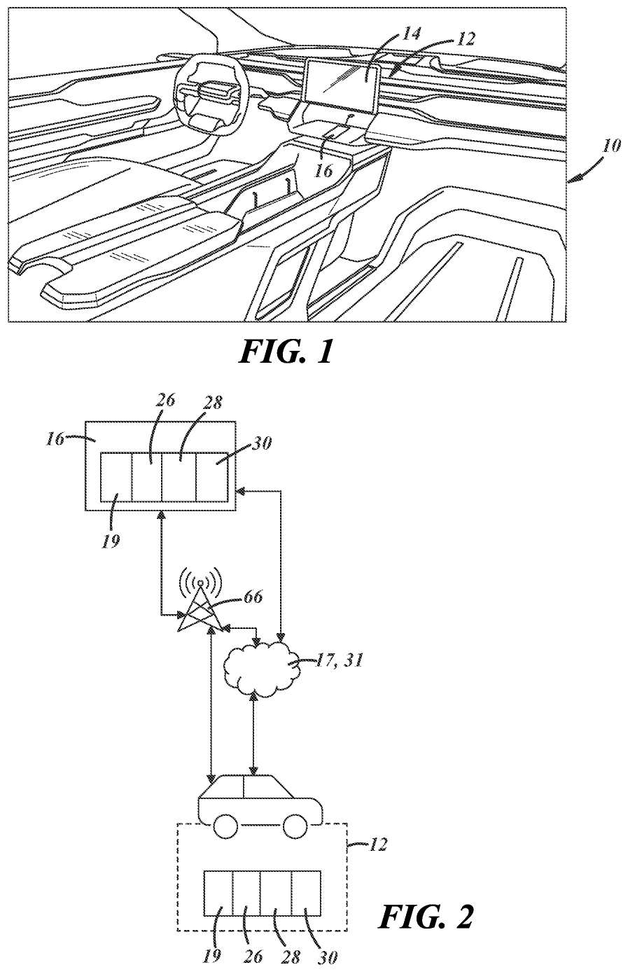

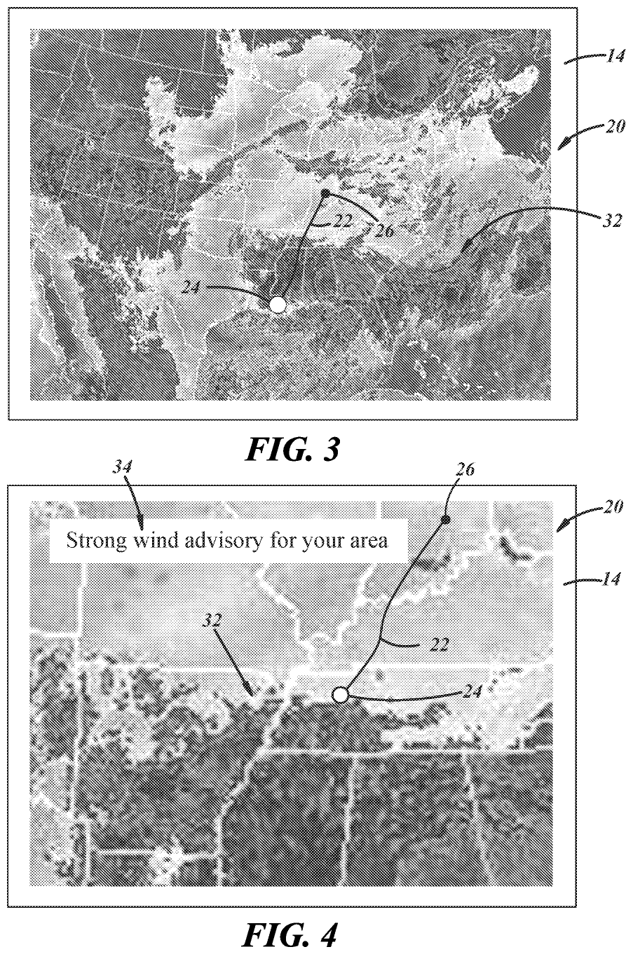

Referring in more detail to the drawings, FIG. 1 illustrates part of a vehicle interior 10 including a HMI system 12 that includes a display screen 14. As shown in FIG. 2, the vehicle HMI system 12 or a remote device 16, such as a mobile phone, tablet or computer, connected to the HMI system 12 may include or communicate with a navigation source 18 such as a remote mapping service or database 17, or an executable program 19 in the HMI system 12 or device 16 that provides or generates map data 20 (FIGS. 3 and 4) that includes a path of travel 22 to a destination of the vehicle, and provides the map data 20 to the display screen 14 to display some or all of the path of travel 22 and surrounding geographic region. As shown in FIGS. 3 and 4, the map data 20 may include an image of the geographic regions being displayed including a depiction of roads, natural features like lakes or rivers, and points of interest which may include things like refueling or recharging stations, restaurants, tourist attractions and the like. The map data 20 may also include a graphic depiction of the path of travel 22 such as a traced path along one or more roads to be taken in the path of travel, and a current location of the vehicle which may be represented by an icon, shown as a dot 24 in FIGS. 3 and 4. The current location may be obtained, for example, by a GPS device, mobile phone or other device triangulation, in known manner. The HMI system 12 or the remote device 16 may include other programs that may be accessed and include features displayed on the display screen.

As shown in FIG. 2, the HMI system 12 and remote device 16 may each include or be communicated with a controller 26, memory 28, and a communications device 30. The map data 20 may be stored in the memory of one or both devices, retrieved from a remote source via the communications device 30 or one or both devices, or any combination of the above. The map data 20 may include, by way of non-limiting examples, the locations and names/identification of roads, speed limits for roads, current speeds of vehicles on roads, historical data regarding speeds at different times of day, voice or text commands associated with vehicle navigation, and information regarding hazards or abnormal road conditions like construction zones, vehicle accidents or lane closures blocking or closing all or portions of a road. The map data 20 is used to determine the path of travel 22 and this may be done based upon one or more different travel criteria such as, by way of non-limiting examples, total distance, total travel time, use of faster roads like highways, avoidance of certain areas, for example, those including unpaved roads, tolls or other fees, and the like. The path of travel 22 may be determined as a function of one or more waypoints including a final destination. Alternatively, or in combination, a user may input all or a portion of a desired path of travel.

Weather conditions, particularly severe weather conditions, can be a concern of many drivers and passengers. Accordingly, the HMI system 12 and/or remote device 16 may include one or more programs arranged to provide improved a weather source 31 for weather information 32, which may include a visual display of weather information 32 along a determined path of travel 22 for the vehicle. By way of non-limiting examples, the communications device 30 or remote device 16 may download or obtain weather information from a remote source 31, like a weather service or weather database. The weather information 32 may include data relating to a rate/intensity of rainfall, visibility, and potential severe weather that includes one or more of wind speeds above a wind threshold (50 mph for example), hail, tornado and dense fog. The weather information 32/weather data may include one or more graphic representations such as radar images and/or animations that depict location and/or movement of clouds, storm systems/clusters or weather systems across a geographic area. The images or animations may include different colors for different severities of the weather information 32 so the relative intensity or severity of weather conditions in different areas can readily be determined.

A representation of different colors within a cloud/weather system are shown in the images of FIGS. 3 and 4, where darker portions include more severe weather conditions than lighter portions, and areas without clouds overhead do not include any overlying weather image/information (areas without clouds appear fully transparent or clear). Further, the weather information 32 may include time-sensitive data relating to current weather conditions, future forecasted weather conditions and past weather conditions.

In addition to or instead of the graphic representations, the weather information 32 may include a textual description 34 (FIG. 4) of the current weather or forecasted weather or an audio file with an audible description of the current or forecasted weather. Such weather information 32 may include, by way of non-limiting examples, messages to advise a driver of potentially hazardous conditions. The messages may be displayed when the weather information 32 exceeds a threshold, for example a low-temperature threshold that may be set to indicate slippery or icy road conditions, or a severe weather threshold that may include a high wind speed threshold, or predicted or confirmed tornadic conditions be set at wind/tornado, or a visibility threshold that may include thresholds for things that affect visibility such as a rate/intensity of rain or fog.

The display screen 14 may include a simultaneous display of map data 20 including a path of travel 22, and weather information 32. This information may be provided in different graphic layers arranged one on top of the other. For example, the map data 20 may be provided as a base or bottom layer and the weather information 32 may be provided in a semi-transparent layer overlayed onto the map data 20. In such an arrangement, the transparency of the weather information 32 may be variable and controllable (e.g. by permitting user adjustment to suit their preference) to, in at least some implementations, permit the underlying map data 20 to be viewable through the weather information 32.

The geographic area displayed on the display screen 14 may be adjusted to show a larger or a smaller geographic region as desired, as shown by comparison of FIGS. 3 and 4. In at least some implementations, the geographic area shown is automatically controlled by the navigation program as a function of the path of travel 22, and/or may be adjusted by user command, such as by actuating inputs of the HMI system 12 that permit zooming into or out of the displayed geographic region. For example, a larger geographic region may be displayed when the vehicle is on a larger road, like a highway, and when the vehicle is not near an upcoming turn in the path of travel, and a smaller geographic region may be provided when the vehicle is in an area with lots of roads or map features, like a city, or is nearing a turn in the path of travel and a closer view of the area including the turn is desired. In FIGS. 3 and 4, the current location of the vehicle is shown by a white-filled dot 24, the final destination is shown by black-filled dot 36 and the path of travel 22 is represented by the line extending between the dots. In FIG. 4, a smaller geographic region is shown than in FIG. 3, and the vehicle is closer to the final destination 36 in FIG. 4 than in FIG. 3.

In at least some implementations, the display of weather information 32 is provided for the geographic region of map data 20 that is displayed on the display screen. Thus, when the geographic region of the map data 20 is changed (e.g. zoomed in or out), the weather information 32 is scaled to match. In one example, where the scale of map data 20 is a certain dimension (e.g. 1-inch) or number of pixels of the screen per 1,000 feet of geographic region, the weather information 32 is a graphic representation that is set to the same scale. While the same scale may be preferred, the weather information 32 could be deemed to match if it is within 5% of the scale of the displayed map data 20.

In addition to being scaled to show a desired geographic region, the map data 20 can also be adjusted to show a different geographic region at a selected scale. That is, the displayed map data 20 can be changed to show laterally adjacent areas, e.g. to the north, south, east or west, of a currently displayed area, which may be called scrolling around the map or map data 20. This may be done, for example, to show on the display screen 14 a future portion of the path of travel 22 at a preferred scale, or for other reasons. When such change in the map data 20 is detected, weather information 32 corresponding to the new map data may also be displayed. That is, the weather information 32 displayed may be changed in the same manner as the change to the map data 20.

Further, when a future portion of a path of travel 22 is displayed, the system may programmed to provide a time-adjusted or time-sensitive display of weather information 32. In this way, a user can view the forecasted weather conditions that they can expect to encounter during a future portion of their travel along the path of travel 22. For example, if the display screen 14 includes map data 20 for a geographic region that the vehicle is estimated to be within two hours from the current time, the forecasted weather information 32 two hours in the future can be provided for the displayed geographic region. If desired, when a future forecasted weather display is provided, the time associated with an image or animation of the forecasted weather can be provided on the screen. The estimated time that a vehicle will be within a displayed geographic region can be determined by the navigation program which can determine a time for various intervals of the trip. Further, in at least some implementations, the timing of the route and display can be adjusted by the user to, for example, accommodate intended stops or diversions along the path of travel.

In at least some implementations, a method of controlling a display screen 14 in a vehicle can be implemented to show map data 20 and weather information 32 on the display screen 14. The method includes steps of obtaining map data 20 including a path of travel 22 and at least part of a geographic region adjacent to the path of travel from a navigation source 18, displaying at least part of the map data 20 on a display screen 14, obtaining a display of weather information 32 from a weather source 31, where the display of weather information 32 is a function of the geographic region (and vehicle location), and adjusting the display of weather information 32 as a function of the part of the map data 20 on the display screen 14 so that the weather information 32 is overlayed on the map data 20 and both the weather information 32 and the map data 20 are visible simultaneously.

The navigation and map data 20, and the weather information 32 may be obtained from any desired remote sources, via the telematics or communications device 30 of the vehicle, or the remote device 16. In some embodiments, at least a portion of the data/information may include third-party information, such as third-party databases, websites, mapping engines or software, graphics engines or software, or the like. Examples of navigation and map data 20 sources include programs like Apple Maps, Google Maps and Waze. Example sources 31 for weather information 32 include the Weather Channel, Accuweather, Weather Underground, the National Weather Service, and the like. While the examples include U.S. based or available programs, suitable sources can be found in other parts of the world and may be implemented in the same manner.

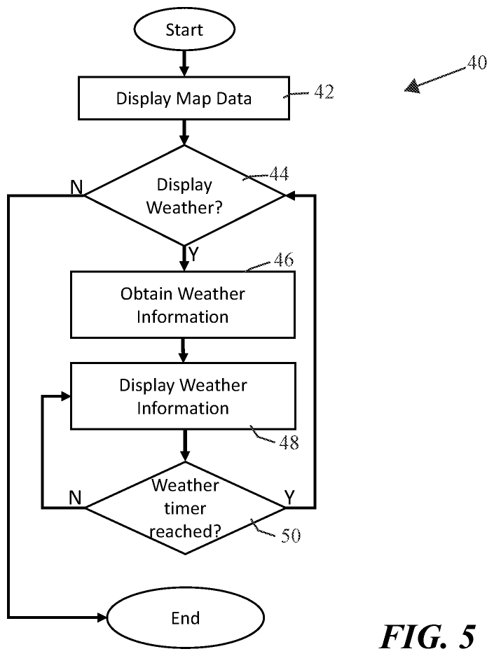

Thus, in the method 40 shown in FIG. 5, when map data 20 for a geographic region is displayed in step 42 on the display screen, the system may determine in step 44 if weather information 32 should also be displayed. The system might be set up to automatically display weather information 32, or a user may select a program option to display the weather information 32 or not. If weather information 32 is to be displayed, the method continues to step 46 in which a search for weather information 32 in the displayed geographic region is performed and weather information 32 is obtained, and then displayed in step 48.

Because weather forecasts can change over time, the system may include a timer set to a desired time interval when the weather information 32 is to be updated. If in step 50 the time threshold has been met, the system may return to step 44 and check if weather information 32 is still to be displayed, and if so, continue to step 46 whereupon weather information 32 is obtained at the new time. In at least some examples, the time threshold may be between 10 and 30 minutes, or at the rate/timing of updates available from the weather data source, with more urgent alerts being pushed through when available.

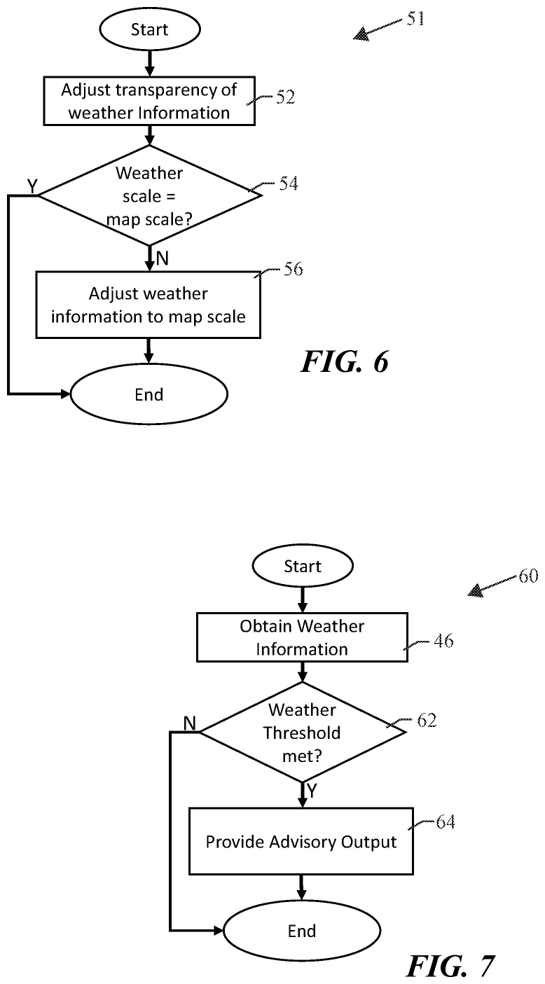

The subroutine or sub-method 51 shown in FIG. 6 may be implemented in the step relating to displaying weather information 32. In step 52, the transparency of the weather information 32 (e.g. the graphic representation of weather) is adjusted to a system or user preselected value or range. Thereafter, the geographic size/scale of the obtained weather information 32 is checked in step 54 against the scale of displayed map data, and if they do not match, then the weather information 32 is scaled to match the map data in step 56.

The subroutine or sub-method 60 shown in FIG. 7 may be implemented in the step relating to obtaining the weather information 32. This method includes in step 62 checking the weather information 32 obtained against one or more weather condition thresholds, such as those mentioned above relating to temperature, wind/severe weather, rain or fog intensity, by way of some examples. For example, there may be a wind speed threshold, a tornado conditions or sighting threshold, a rain intensity threshold or a fog threshold. In at least some implementations, if one or more weather condition thresholds are met, then in step 64 a corresponding advisory output or warning is provided. The output may be visual and provided on the display screen (e.g. text or flashing icon, or flashing area of a radar image) or audible and provided from a speaker or audio output of the HMI system 12.

The systems and methods noted herein provide optional simultaneous display of map data and weather information. The map data may include a path of travel and the weather information that is displayed may be relevant to the intended path of travel. The map data 20 and weather information 32 can be obtained by any program from any local or remote source, such as by the communications device 30 or portion of either or both the remote device 16 and HMI system 12 which may communicate with cellular/GPS towers 66 (FIG. 2), remote cloud-based databases or the like (shown at 17, 31 in FIG. 2). A user can thus determine the forecasted weather for the entire area of the path of travel, or portions thereof, including a geographic portion in which the vehicle is currently located and/or portions of the travel path in which the vehicle will later be located. If desired, the travel path can be altered in view of the weather information, or the time of travel can be adjusted, to avoid areas in which, for example, severe weather or condition causing poor visibility, is predicted. As a function of the map data, weather information can be obtained and displayed, with a suitable scale and transparency to permit simultaneous viewing of both the map data and weather information.

What is claimed is:

1. A method of controlling a display screen in a vehicle, comprising:
obtaining map data including a path of travel and at least part of a geographic region adjacent to the path of travel from a navigation source;
displaying at least part of the map data on a display screen;
obtaining a display of weather information from a weather source, where the display of weather information is a function of the geographic region;
adjusting the display of weather information as a function of the part of the map data on the display screen so that the weather information is overlayed on the map data and both the weather information and the map data are visible simultaneously.

2. The method of claim 1 wherein the step of adjusting the display of weather information includes adjusting a scale of the weather information as a function of a scale of the map data.

3. The method of claim 2 wherein the step of adjusting the display of weather information includes adjusting the transparency of the display of weather information so that the map data is visible through the display of weather information.

4. The method of claim 1 wherein the step of adjusting the display of weather information includes adjusting the transparency of the display of weather information so that the map data is visible through the display of weather information.

5. The method of claim 4 wherein the weather information is provided in a first layer displayed on the display screen and the map data is provided on a second layer displayed on the display screen.

6. The method of claim 1 wherein the weather information includes time-sensitive data for the weather as a function of the estimated time of vehicle travel along portions of the path of travel.

7. The method of claim 1 which includes the method of matching the weather information displayed to the estimated time of vehicle travel through the portion of the path of travel actively displayed on the display screen.

8. The method of claim 7 wherein a current time-wise weather information is displayed when the portion of the path of travel actively displayed includes the current location of the vehicle.

9. The method of claim 7 wherein a forecasted weather information is displayed when the portion of the path of travel actively displayed includes a future location of the vehicle.

10. The method of claim 7 wherein the portion of the path of travel being actively displayed is less than the entire path of travel.

11. The method of claim 1 wherein the weather information includes data regarding rate of rainfall, wind speeds, and potential severe weather that includes one or more of wind speeds above a wind threshold, hail, tornado and fog.

12. The method of claim 11 wherein the data includes graphic representations that include different colors for different severities of the data.

13. The method of claim 1 wherein the weather information includes a textual description of the current weather or forecasted weather.

14. The method of claim 1 which includes comparing the weather information to one or more weather thresholds and issuing an advisory output if one or more of the weather thresholds are met.

15. The method of claim 14 wherein the one or more weather thresholds include a temperature threshold.

16. The method of claim 14 wherein the one or more weather thresholds includes a wind speed threshold, a tornado forecast threshold, a rain intensity threshold or a fog threshold.

17. The method of claim 1 wherein the step of displaying at least part of the map data on a display screen includes displaying the current location of the vehicle on the display screen.

18. A vehicle infotainment system, comprising:
a display screen;
a controller coupled to the display screen and adapted to control content displayed on the display screen;
a navigation source communicated with the controller and adapted to provide map data including a path of travel to the controller for display on the display screen; and
a communications device coupled to the controller and adapted to obtain the map data from the navigation system for display on the display screen, and to obtain weather information from a weather source, wherein the weather information relates to a geographic area that is a function of the map data, and the controller is adapted to adjust a display size of the weather information as a function of a display size of the map data, and the controller is adapted to adjust a transparency of the display of weather information and overlay the weather information over the display of the map data with both the weather information and the map data simultaneously visible on the display screen.
